(19) United States
(12) Patent Application Publication
(10) Pub. No.: US 2010/0228627 A1
(43) Pub. Date: Sep. 9, 2010

(54) Method, System and Apparatus for Electronic Business Suited for Conventional Retailing

(75) Inventors: Lei Hong, Hangzhou (CN); Feng Yu, Hangzhou (CN)

Correspondence Address: LEE & HAYES, PLLC, 601 W. RIVERSIDE AVENUE, SUITE 1400, SPOKANE, WA, 99201, US

(73) Assignee: ALIBABA GROUP HOLDING LIMITED, Grand Cayman (KY)

(21) Appl. No.: 12/161,684

(22) PCT Filed: Jul. 21, 2008
(86) PCT No.: PCT/US08/70660

§ 371 Date: Dec. 17, 2009

(30) Foreign Application Priority Data
Aug. 17, 2007 (CN) 200710143683.6

(51) Int. Cl. G06Q 30/00; G06Q 20/00; G06Q 10/00; G06Q 99/00

(52) U.S. Cl. 705/14.51

(57) ABSTRACT

An electronic business method and system suited for conventional retailers are disclosed. A business transaction server receives from a seller an order form of a product, stores the received order form, assigns an order identification to the product, and communicates the order identification to the seller, who advertises the product with the order identification in any desirable manner including conventional advertising venues such as printed materials. The business transaction server receives from a buyer a purchase order containing the order identification and payment information, and notifies the seller to ship the product to the buyer according to the purchase order. The seller can be a conventional retailer and does not have to rely on Internet for advertisement in order to take advantage of electronic business transactions.

### RELATED APPLICATIONS

This application is a national stage application of international patent application PCT/US08/70660, filed Jul. 21, 2008, claiming priority from Chinese patent application, Application No. 200710143683.6, filed Aug. 17, 2007, entitled “METHOD, SYSTEM AND APPARATUS FOR ELECTRONIC BUSINESS SUITED FOR CONVENTIONAL RETAILING”.

### BACKGROUND

Electronic commerce (e-commerce) uses computer technologies, network technologies, and remote communication technologies to digitalize the trading processes and other business transactions and conduct the electronic transactions over the network. In e-commerce, people no longer conduct face-to-face business transactions by examining the actual products and paper-based documents, including cash, receipts invoices and other transaction records. Instead, the trading (buying and selling) is accomplished using the network, and takes advantage of much broader collections of products made available online and more sophisticated logistics for distribution and delivery.

An e-commerce transaction may be viewed as having three different stages as described below.

The first stage is an information exchange stage. For a seller (e.g., a merchant or service provider), the stage is for collecting product information and advertising and promoting the product by promulgating product information. This includes selecting an inventory of products for sale, collecting and organizing the product information, building e-commerce websites, and joining Internet portals (such as Alibaba.com and taobao.com) which are well-known, highly influential and have high viewer click-through-rates, in order to effectively advertise the products. For a buyer (or a customer), this stage is for searching products and their information. This primarily includes searching on the Internet for a desirable or needed product, studying the product information, and selecting a seller which has a good reputation, good customer services and good prices. The buyer is ready to place an order after having selected a product and a seller.

The second stage is a purchase agreement stage. Between the seller and the buyer, the stage is for actually placing and accepting an order of the product. The buyer places an order by submitting order information which may include the product information and payment information. The order information may also include buyer's contact information, shipping method and payment method. The seller may confirm the received order information by, for example, e-mail or telephone.

The third stage includes shipping and delivery of the product and fund settlements according to the purchase agreement. This is a critical stage for the transaction because it requires accurate and secure payment, and accurate and timely delivery of the product in order to complete the transaction.

The present e-commerce processes such as electronic retailing completely relies on the Internet. The seller advertisers and displays its products on the Internet and the buyer searches and selects the products, places an order and makes a payment on the Internet. Especially in the above-described first stage (information exchange stage), the seller must use the Internet to advertise and display the products to be sold in electronic retailing. The seller cannot freely choose its preferred or customary means of advertisement, such as those used in conventional retailing. For example, suppose a seller is good at television advertisements and is able to receive good benefits by advertising on TV. If the seller now wants to take advantage of electronic retailing or online retailing, the seller cannot continue to use TV advertisements. Instead, the seller must develop its own e-commerce website to advertise the products. This may require the seller to spend a great deal of money on a sophisticated e-commerce website with high-quality photos of the products in order to increase its reputation and compete with others sellers.

Therefore, one problem with the present e-commerce technology is that the Internet is only media to conduct an e-commerce transaction. Such e-commerce technology is unsuitable for traditional retailing models as it renders the traditional off-line displaying and advertising techniques and resources customary to the conventional retailers useless, seriously restricting the advertising capabilities of the seller. Furthermore, using the present e-commerce technology, both the seller and the buyer are often required to install certain software such as client software to facilitate the transaction, further increasing the complexity of the transaction.

### SUMMARY

Disclosed is an electronic business method and system suited for conventional retailing. A business transaction server receives from a seller an order form of a product, stores the received order form, assigns an order identification to the product, and communicates the order identification to the seller, who advertises the product with the order identification in any manner, including conventional advertising venues such as printed materials. The business transaction server receives from a buyer a purchase order containing the order identification and payment information, matches the order identification contained in the purchase order to the order identification stored at the business transaction server, and establishes a transaction associated with the purchase order. The business transaction server then notifies the seller to ship the product to the buyer according to the purchase order. The seller can be a conventional retailer and does not have to rely on Internet for advertisement in order to take advantage of electronic business transactions.

In some embodiments, advertising the product is conducted by publishing the order identification any suitable media. Examples of suitable media include but not limited to a conventional printed material, radio, TV, an electronic message, and a webpage. Advertising the product may further include indicating in the advertisement a preferred or required payment method. The advertisement may also include information of the business transaction server.

In one embodiment, the purchase order is contained in any one or a combination of an instant message, an SMS message, an e-mail, a regular mail, an input entered through a bank payment system, and an input entered through an online payment system. The purchase order can be sent by the buyer using various methods and various devices, including computer terminals and portable devices.

Upon completion of the transaction, the business transaction server may update the order form of the product based on the purchase order. Such update can be conducted by the business transaction server without requiring an action of the seller.

The order form may prescribe a payment method preferred or required by the seller, and accordingly the business transaction server may instruct or require the buyer to make a payment using the payment method prescribed in the order form.

In one embodiment, the business transaction server holds the payment received from the seller until a payment release condition has been satisfied. The payment release condition may be receiving a feedback from the buyer indicating a satisfactory receipt of the product. The business transaction server transfers the payment to the seller only after the payment release condition has been satisfied. To facilitate such secure payments, the business transaction server may have a funds holding account to hold the payments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is a structural diagram of an exemplary electronic business transaction system suited for conventional retailing.

FIG. 2 shows a flow chart of an exemplary method for electronic business transaction suited for conventional retailing.

FIG. 3 shows an exemplary environment for implementing the method of the present disclosure.

### DETAILED DESCRIPTION

The present disclosure is a solution to a disconnection between the conventional advertising methods customary to traditional retailers and the e-commerce technologies such as electronic retailing (or online retailing). Exemplary embodiments disclosed herein introduce an e-commerce method that does not have to completely rely on the Internet, but is suitable for conventional retailing model as well. A seller (a merchant or a service provider) may choose to advertise the products using whatever methods the seller is used to or good at, including the conventional advertisement methods such as printed materials (newspapers, catalogs and magazines), radios, TV, regular mail, demos, as well as electronic methods such as e-mails, instant messages, SMS messages (cellular phone text messaging) and webpages, yet still enjoy the benefits of an e-commerce transaction including online order, online payment, and online communication. These benefits include convenience, speed, low cost and high efficiency compared to traditional retailing methods.

A business transaction server is used to support the electronic retailing. The owner of the business transaction server may focus on receiving and placing orders and is not required to spend resources on other matters such as developing and maintaining websites, and storing and updating of product photos, thus lightening the burden of the business transaction server. Likewise, the seller is not required to be a real electronic retailer by maintaining a sophisticated e-commerce website in order to benefit from electronic transactions. In some embodiments, the buyer may also choose a convenient payment method. In contrast, in the present e-commerce technology, a seller can only advertise the products on the Internet using a website in order to take advantage of the e-commerce technology.

Exemplary embodiments of practical implementations are described in further details below with reference to several figures.

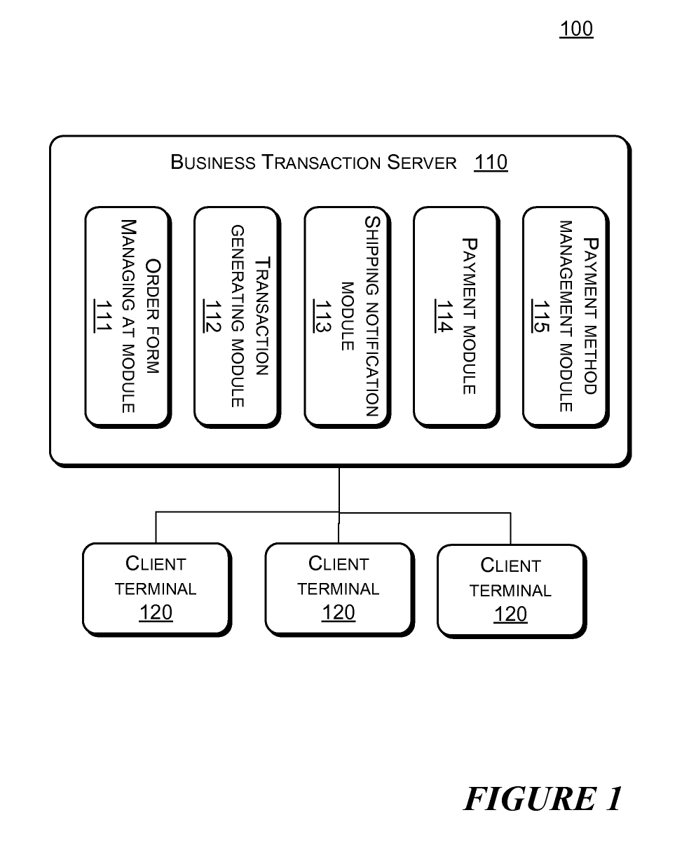

FIG. 1 is a structural diagram of an exemplary electronic business transaction system that is suited for conventional retailing. The system 100 in FIG. 1 is based on a business transaction server 110, which is connected to client terminals 120. The client terminals 120 are representative of multiple user terminals that may be connected to the business transaction server 110. Through multiple client terminals 120, multiple users (including both buyers and users) may access the electronic business transaction system 100 hosted on business transaction server 110.

In practice, a seller submits an order form of a product through one of the client terminals 120 to the business transaction server 110. The order form of the product has transaction information related to the product, including, for example, a description of the product (such as a name, features and specifications), unit price, quantity available, and buyer's contact information. The order form may be in any format agreed between the buyer and the business transaction server 110, or any format acceptable by the business transaction server 110.

Upon receiving the order form of the product, the business transaction server 110 assigns an order identification to the product (or to the order form of the product) and subsequently communicates the order identification to the seller. The order identification can be any information that may be used to identify the product by the business transaction server 110. The order identification does not have to be descriptive of the product itself. One example of the order identification is an alphanumerical serial number, or even a simple serial number. The seller may only need to submit enough information of the product for the business transaction server 110 to assign an order identification. Because the submission of product information by the seller to the business transaction server 110 is not for advertising the product, the seller does not need to prepare and submit complex information such as product photos and multimedia information (which may often be necessary in the present electronic retailing in which the seller is required to do online advertisements of the product). For this reason, there is no special requirement for the client terminal 120 used by the seller to submit an order information of a product. The client terminal 120 may be, for example, a computer terminal or a portable device such as a cell phone (including smart phones). The seller may enter the order form of a product anytime and in any place without requiring special equipment or computer knowledge, and receive a corresponding order identification of the product from the business transaction server 110. In one embodiment, the business transaction server 110 may assign the order identification and send it to the seller immediately upon receiving the order form from the seller.

After receiving the order identification of the product from the business transaction server 110, the seller then advertises the product in whatever desirable or preferred manner. Advertising of the product may be conducted using any media, including but not limited to a conventional printed material, radio, TV, an electronic message, and a webpage. In addition to providing a description of the product for the advertising purpose, the advertisement includes the order identification of the product received from the business transaction server 110 so that a potential buyer may be able to identify the product when placing an order on the business transaction server 110. The advertisement may also include information of the business transaction server 110, for example a portal name (such as Taobao.com) to access the business transaction server 110. The advertisement may further include a preferred or required payment method.

Although the seller may advertise using any methods, including the off-line advertising methods, the seller does not need to sell the product using conventional retailing methods, such as by maintaining a physical shop, renting a vendor's store, etc. Instead, the seller benefits from the online transaction service provided by the business transaction server 110 without having to maintain an e-commerce website on the seller's side. The benefits of the online transaction include speediness, convenience, low-cost, and high efficiency. In addition, compared to direct online transaction between the seller and the buyer, the online transaction is facilitated by the business transaction server 110 serving as a third party “middleman” or an intermediary payment platform, thus maximizing the security of the transaction and avoiding fraud in online transactions.

In some embodiments, the seller may choose a preferred or required payment method. For example, the seller may choose to accept online payment (such as Alipay) and bank card payment. With this choice, the business transaction center 110 may accept these specified payment methods only when taking an order from a buyer. The payment method preference may be explicitly indicated in the order form. Alternatively, each seller may maintain a seller account or a seller profile at the business transaction center 110 to keep information of such preferences. For example, the seller may choose a default payment method for all products (or a certain kind of products) sold by the seller, and indicate such default payment method in the seller account or the seller profile. This way, the seller does not need to include payment method in the order form of each product, unless there is a special payment method requirement or preference for a certain product different from the default payment method.

The assignment of order identifications of products by the business transaction server 110 preferably allows as much freedom as possible to the seller. The seller may apply for order identifications according to the needs of the seller's own products. For instance, if a certain style or design of the seller's product has assorted colors, and the seller determines that the color is inconsequential for the transaction and may ship any color of the same product to an order of the product, the seller may apply for just one order identification for the same product of all colors. But if the seller determines that the color of the product is consequential for the transaction and the product of a correct color must be shipped to the buyer, the seller may apply for a different order identification for each color of the product.

In the advertisement, the seller may instruct the buyer on how to use the order identification to place on online order. For example, the advertisement may instruct the buyer to take note of the order identification of the product the buyer is interested by, visit an online shopping portal supported by the business transaction server 110, and place an online order by providing the order identification. If the order form includes a choice of payment method, the advertisement may also indicate such choice of payment method.

The buyer places an order of the product by submitting a purchase order to the business transaction server 110. The purchase order can be sent in any suitable format, either electronically or in paper. For example, the purchase order can be contained in any one or a combination of an instant message, an SMS message, an e-mail, a regular mail, a telephone call, an input entered through a bank payment system, and an input entered through an online payment system.

The purchase order contains the order identification of the product being purchased and payment information. The buyer makes the payment using the preferred or required payment method advertised. Depending on the seller's choice, the payment method may be any method that is available and feasible. For example, the buyer may use SMS messaging, e-mail, bank payment, online payment or regular mail to make a payment. The business transaction server 110 is adapted to accept many payment method the seller wishes to use. Examples of commonly accepted payment methods include withholding and remitting by an authorized agent, and payment using a cell phone. An example of online payment is the express payment channel supported by Alipay (Alipay.com) in which the buyer may enter the order identification number to make a quick payment online. The buyer may also use payment service of a bank or postal office to make a payment corresponding to the order identification. The electronic business transaction system 100 thus reduces the complexity of making a payment by the buyer.

Upon receiving the purchase order from the buyer, the business transaction server 110 matches the order identification contained in the purchase order to the order identification stored at the business transaction server 110, and identifies the product to be purchased and the seller of the product. The business transaction server 110 establishes a transaction according to the purchase order which contains the order identification of the product being purchased and payment information. The business transaction server 110 then notifies the seller to ship the product to the buyer according to the purchase order. The seller ships the product (or notifies a logistics group or company to ship the product). After the product has been shipped (or after the transaction has been completed), the business transaction server 110 updates the order form of the product based on the purchase order. For instance, the order form of the product may be updated to reflect the available quantity of the product after the transaction.

As shown in FIG. 1, the business transaction server has an order form managing module 111, a transaction generating module 112, a shipping notification module 113, a payment module 114, and a payment method management module 115. These modules are used to perform the functions described above.

Specifically, the order form managing module 111 is used to receive from the seller the order form of the product, store the received order form, assign an order identification to the product (or to the order form of the product), and communicate the order identification to the seller which advertises the product with the order identification. The order form management module 111 may also be used to update the order form of the product based on the purchase order.

The seller may continue to use the same order identification for the same product for the future sales of the product. If the quantity of the product entered with the order form is exhausted, the seller may log on to the business transaction server 110 to update the order form with a new quantity of the product and continue to use the same order identification. The seller does not need to apply for a new order identification in order to continue to sell the same product. Because a new order identification would require changes to the advertisement and render the previous advertisements bearing the order identification ineffective or even useless, being able to keep the same order identification number saves advertisement expenses.

The transaction generating module 112 is used to receive from the buyer the purchase order containing the order identification and payment information, and establish a transaction according to the purchase order.

The shipping notification module 113 is used to notify the seller to ship the product to the buyer according to the purchase order.

The payment module 114 is used to receive payment from the buyer and transfer the payment to the seller after a payment release condition has been satisfied. The payment release condition may be satisfied upon receiving a feedback from the buyer indicating a satisfactory receipt of the product. Using the payment module 114, the business transaction server 110 serves as an intermediary payment platform to increase the security and reliability of the transaction.

The payment method management module 115 is used to determine the preferred or required payment method based on the order form, and to accept payment made using the preferred or required payment method. The payment method management module 115 may instruct or require the buyer to make a payment using the payment method prescribed in the order form, and may decline a payment made using a method different from the preferred or required payment method.

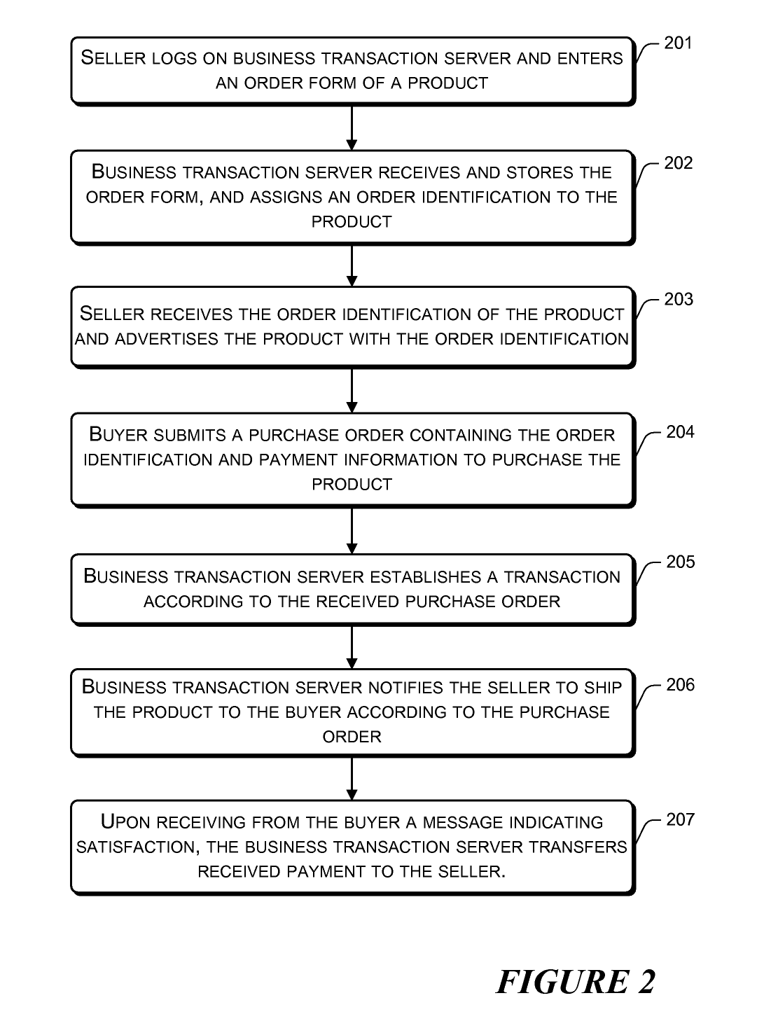

FIG. 2 shows a flow chart of an exemplary method for electronic business transaction suited for conventional retailing. In this description, the order in which a process is described is not intended to be construed as a limitation, and any number of the described process blocks may be combined in any order to implement the method, or an alternate method.

At block 201, the seller logs on the business transaction server 110 and enters the order form of the product to be sold. To do this, the seller may use any suitable client terminal such as a computer terminal, a smart phone, and a personal digital assistant (PDA). The order form may include the name of the product, unit price, available quantity and seller's contact information. Because the order form only needs to include information of the product necessary to complete a transaction and is not submitted for the purpose of advertisement by the business transaction server 110, there is no need for the seller to prepare and transmit fancy information (such as high-quality photos) to the business transaction server 110. The seller may enter the order form of the product anytime and in any place. In some embodiments, the seller may choose a preferred or required payment method. For example, the seller may choose to accept online payment (such as Alipay) and bank card payment only. Accordingly, the business transaction server 110 may accept only a payment method selected by the seller.

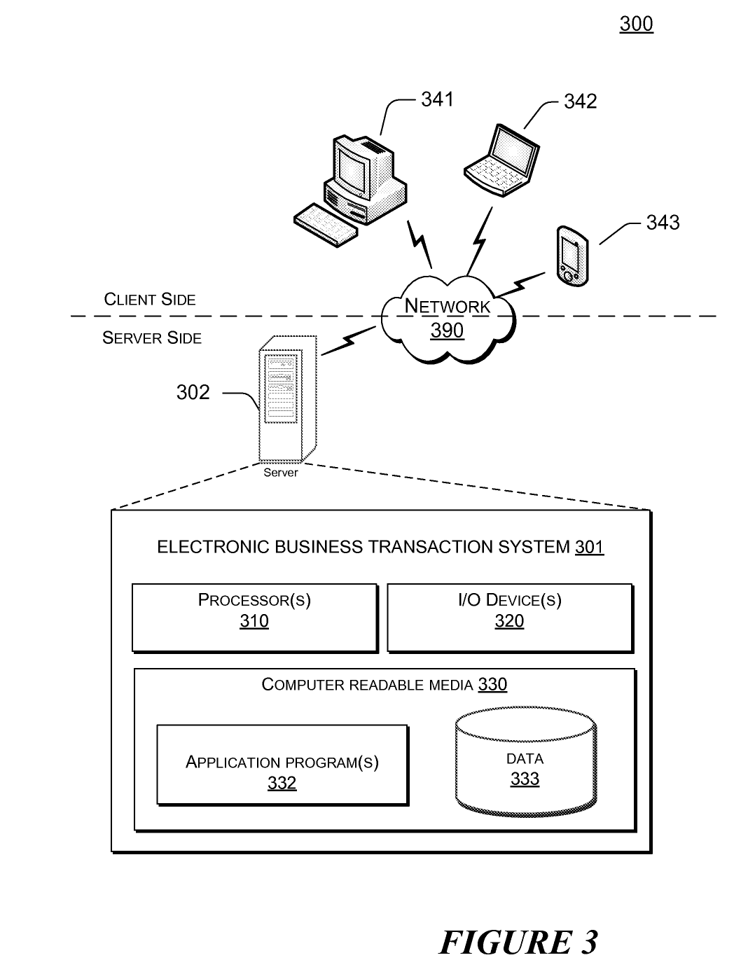

At block 202, business transaction server 110 receives the order form and stores the received order form in a storage device (e.g., a computer readable media 330 as shown in FIG. 3 below).

The business transaction server 110 then assigns an order identification to the product and communicates the order identification to the seller. The order identification can be any information of any format that may be used to identify the product by the business transaction server 110. The assignment of order identifications of products by the business transaction server 110 preferably allows as much freedom as possible to the seller. The seller may apply for order identifications according to the needs of the seller's own products. For instance, if a certain style or design of the seller's product has assorted colors, and the seller may either apply for just one order identification for the same product of all colors, or apply for a different order identification for each color of the product, depending on the importance of the color. The seller may continue to use the same order identification for the same product even if the product entered with the initial order form has been sold out. To do this, the seller logs on to the business transaction server 110 to update the order form with a new quantity of the product and continues to use the same order identification to advertise the product.

At block 203, seller receives the order identification of the product and advertises the product with the order identification. The seller advertises the product in whatever desirable manner. Advertising of the product may be conducted using any media, including but not limited to a conventional printed material, radio, TV, an electronic message, and a webpage. The advertisement should generally include the order identification of the product received from the business transaction server 110 so that a potential buyer may be able to identify the product when placing an order on the business transaction server 110.

The advertisement may also include information of the business transaction server 110 in order to direct the potential buyers to the business transaction server 110 to place an order of the product. For example, in order to inform the potential buyers where the advertised order identification can be used to make a purchase, the advertisement may include a web portal name (such as Taobao.com) which accesses the business transaction server 110 through Internet. It is appreciated that more than one web portals may be used for this purpose.

The advertisement may further include a preferred or required payment method. The seller thus benefits from the online transaction service provided by the business transaction server 110 without having to maintain an e-commerce website on the seller's side. In addition, compared to direct online transaction between the seller and the buyer, the online transaction may be facilitated by the business transaction server 110 serving as an intermediary payment platform, which maximizes the security of the transaction and avoids fraud in online transactions.

At block 204, buyer submits a purchase order containing the order identification and payment information to the business transaction server 110. The purchase order can be sent in any suitable format, either electronically or in paper. The buyer places an order of the product by submitting a purchase order. The purchase order contains the order identification of the product be purchased and payment information. The buyer makes the payment using the preferred or required payment method advertised. The business transaction server 110 may instruct or require the buyer to make a payment using the payment method prescribed in the order form, and thereafter receive the payment made by the buyer use an appropriate payment method. Depending on the seller's choice, the payment method may be any method that is available and feasible. For example, the buyer may use SMS messaging, e-mail, bank payment, online payment or regular mail to make a payment. The business transaction server 110 may be adapted to accept many payment methods the seller wishes to use. The electronic business transaction system 100 thus reduces the complexity of making a payment by the buyer.

At block 205, the business transaction server 110 establishes the transaction by generating a transaction record according to the purchase order which contains the order identification of the product being purchased and payment information. Upon receiving the purchase order from the buyer, the business transaction server 110 matches the order identification contained in the purchase order to the order identification stored at the business transaction server, and identifies the product to be purchased and the seller of the product.

At block 206, the business transaction server 110 notifies the seller to ship the product to the buyer according to the purchase order. After the product has been shipped, the business transaction server 110 updates the order form of the product based on the purchase order. The update may be done by the business transaction server 110 automatically without requiring an action of the seller.

At block 207, the business transaction server 110 receives a feedback from the buyer. For example, the feedback may be a message from the buyer indicating whether the delivery has been successful, the product is in satisfactory condition, and the transaction has been satisfactory. The feedback from the user may be used as a payment release condition to decide whether the payment can be transferred from the business transaction server 110 to the seller. If the payment release condition is satisfied, the business transaction server 110 transfers the payment to the seller. The business transaction server 110 thus serves as an intermediary payment platform to increase the security and reliability of the electronic transaction. In order to perform such payment holding functions, the business transaction server 110 may have of funds holding account, either built in the server 110, or located on another place and accessible by the business transaction server 110 over the network.

The above exemplary method for electronic business transaction makes it possible for the seller not to completely rely on Internet for an electronic transaction, especially in the advertisement. The method is suited for conventional retailing. The seller has the freedom to choose an advertiser method which the seller is good at or accustomed to. In some embodiments, the seller and buyer may select a payment method that is convenient to use.

### Implementation Environment

The above-described techniques may be implemented with the help of a computing device, such as a server or a personal computer (PC) having a computing unit.

FIG. 3 shows an exemplary environment for implementing the method of the present disclosure. In illustrated system 300, some components reside on a client side and other components reside on a server side. However, these components may reside in multiple other locations. Furthermore, two or more of the illustrated components may combine to form a single component at a single location.

Electronic business transaction system 301 is implemented with a computing device 302 which is preferably a server and includes processor(s) 310, I/O devices 320, computer readable media 330, and network interface (not shown). The computer device 302 is connected to client-side computing devices (client terminals) such as 341, 342 and 343 through network(s) 390. In one embodiment, computing device 302 is an electronic transaction server described herein (e.g., electronic transaction server 110), while client-side computing devices 341, 342 and 343 may each be a computer or a portable device, used as a user terminal as described herein.

The computer readable media 330 stores application program modules 332 and data 334 (such as using information, group information and messages). Application program modules 332 contain instructions which, when executed by processor(s) 310, cause the processor(s) 310 to perform actions of a process described herein (e.g., the illustrated process of FIG. 2). An exemplary process that can be performed by the electronic business transaction system 301 by executing instructions stored in computer readable media 330 is as follows: receiving from a seller an order form of a product; storing the received order form at a business transaction server; assigning an order identification to the product and communicating the order identification to the seller which advertises the product with the order identification; receiving from a buyer a purchase order containing the order identification and payment information; and notifying the seller to ship the product to the buyer according to the purchase order.

It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. Especially, computer device 302 may be a server computer, or a cluster of such server computers, connected through network(s) 390, which may either be Internet or an intranet.

As illustrated above, the electronic business transaction method and system described herein provides a unique connection and interaction among several parts of an electronic business transaction, for example product order forms, transaction orders and payments, to facilitate electronic business transactions under various technological backgrounds of the participating parties (seller, buyer and the intermediary agent). The seller has the freedom to choose its own preferred product advertisement and promotion method(s) which may include both online methods and conventional off-line methods. The business transaction server can support a broad range of payment methods to allow different sellers and buyers to choose their own preferred payment method. The electronic business transaction method and system described herein does not have to completely rely on Internet technologies, but instead allows traditional retailers to utilize their own preferred advertising channels, and still be able to take advantage of the convenient, speedy, low-cost, and efficient electronic business transactions.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for conducting electronic business, the method comprising:
receiving from a seller an order form of a product;
storing the received order form at a business transaction server;
assigning an order identification to the product and communicating the order identification to the seller which advertises the product with the order identification;
receiving from a buyer a purchase order containing the order identification and payment information; and
notifying the seller to ship the product to the buyer according to the purchase order.

2. The method as recited in claim 1, wherein the order identification comprises an alphanumerical serial number.

3. The method as recited in claim 1, further comprising:
matching the order identification contained in the purchase order to the order identification stored at the business transaction server.

4. The method as recited in claim 1, wherein the purchase order is contained in any one or a combination of an instant message, an SMS message, an e-mail, a regular mail, a telephone call, an input entered through a bank payment system, and an input entered through an online payment system.

5. The method as recited in claim 1, wherein the purchase order is sent from a portable device.

6. The method as recited in claim 1, further comprising:
establishing at the business transaction server a transaction according to the purchase order.

7. The method as recited in claim 1, further comprising:
updating the order form of the product based on the purchase order.

8. The method as recited in claim 7, wherein updating the order form is conducted by the business transaction server without requiring an action of the seller.

9. The method as recited in claim 1, further comprising:
receiving at the business transaction server a payment made by the buyer.

10. The method as recited in claim 1, wherein the order form prescribes a payment method preferred or required by the seller, and the method further comprising:
instructing or requiring the buyer to make a payment using the payment method prescribed in the order form; and
receiving at the business transaction server the payment made by the buyer.

11. The method as recited in claim 1, further comprising:
advertising the product by publishing the order identification in a media comprising any of a conventional printed material, radio, TV, an electronic message, and a webpage.

12. The method as recited in claim 11, wherein advertising the product further comprises indicating a preferred or required payment method.

13. The method as recited in claim 11, wherein advertising the product includes information of the business transaction server.

14. The method as recited in claim 1, further comprising:
receiving a feedback from the buyer.

15. The method as recited in claim 1, further comprising:
receiving a payment for the product from the buyer; and
holding the payment from the seller until a payment release condition has been satisfied.

16. The method as recited in claim 15, wherein the payment release condition comprises receiving a feedback from the buyer indicating a satisfactory receipt of the product.

17. The method as recited in claim 15, further comprising:
transferring the payment to the seller after the payment release condition has been satisfied.

18. The method as recited in claim 15, wherein the business transaction server has a funds holding account to hold the payment.

19. An electronic business transaction system comprising:
an order form managing module to receive from a seller an order form of a product, store the received order form, assign an order identification to the product, and communicate the order identification to the seller which advertises the product with the order identification;
a transaction generating module to receive from a buyer a purchase order containing the order identification and payment information, and establish a transaction according to the purchase order; and
a shipping notification module to notify the seller to ship the product to the buyer according to the purchase order.

20. The system as recited in claim 19, wherein the server further includes:
a payment method management module to determine a preferred or required payment method based on the order form, and to accept a payment based on the preferred or required payment method.

21. The system as recited in claim 19, wherein the server further includes:
a payment module to receive a payment from the buyer and transfer the payment to the seller after a payment release condition has been satisfied.

22. An electronic business transaction system comprising a server communicating to user terminals, wherein the server is adapted to perform the following:
receiving from a seller an order form of a product;
storing the received order form at a business transaction server;
assigning an order identification to the product and communicating the order identification to the seller which advertises the product with the order identification;
receiving from a buyer a purchase order containing the order identification and payment information; and
notifying the seller to ship the product to the buyer according to the purchase order.
